(19) United States
(12) Patent Application Publication
(10) Pub. No.: US 2015/0064968 A1
(43) Pub. Date: Mar. 5, 2015

(54) RECEPTACLE ASSEMBLY HAVING A PLURALITY OF TERMINATION POINTS

(71) Applicant: Tyco Electronics Corporation, Berwyn, PA (US)

(72) Inventors: Wayne Samuel Davis, Harrisburg, PA (US); Robert Neil Whiteman, JR., Middletown, PA (US); Kyle Gary Annis, Hummelstown, PA (US); Alex Michael Sharf, Harrisburg, PA (US); Dave Helster, Dauphin, PA (US); Dharmendra Saraswat, Harrisburg, PA (US); Timothy Robert Minnick, Enola, PA (US)

(73) Assignee: Tyco Electronics Corporation, Berwyn, PA (US)

(21) Appl. No.: 14/012,380

(22) Filed: Aug. 28, 2013

(51) Int. Cl. H01R 13/6599

(52) U.S. Cl. CPC H01R 13/6599
USPC 439/607.02

(57) ABSTRACT

A receptacle assembly includes a contact module having a conductive holder and a frame assembly held by the conductive holder. The conductive holder has a first holder member and second holder member coupled to the first holder member. The conductive holder has a chamber between the first and second holder members divided into a plurality of channels by first tabs of the first holder member and second tabs of the second holder member. The first tabs have posts extending therefrom and the second tabs have holes receiving the posts of the first tabs. Each post has a plurality of termination points with the corresponding tab. The first and second holder members are electrically connected to one another at the termination points. The first and second tabs pass between contacts of the frame assembly to provide electrical shielding therebetween.

### BACKGROUND OF THE INVENTION

The subject matter herein relates generally to receptacle assemblies having a shielding structure with a plurality of termination points.

Some electrical systems utilize electrical connectors to interconnect two circuit boards, such as a motherboard and daughtercard. In some systems, to electrically connect the electrical connectors, a midplane circuit board is provided with front and rear header connectors on opposed front and rear sides of the midplane circuit board. Other systems electrically connect the circuit boards without the use of a midplane circuit board by directly connecting electrical connectors on the circuit boards.

However, as speed and performance demands increase, known electrical connectors are proving to be insufficient. Signal loss and/or signal degradation is a problem in known electrical systems. Additionally, there is a desire to increase the density of electrical connectors to increase throughput of the electrical system, without an appreciable increase in size of the electrical connectors, and in some cases, with a decrease in size of the electrical connectors. Such increase in density and/or reduction in size causes further strains on performance.

In order to address performance, some known systems utilize shielding to reduce interference between the contacts of the electrical connectors. However, the shielding utilized in known systems is not without disadvantages. For instance, the shielding along the signal channels may be subject to ground induced noise resonances, particularly at higher frequencies. In the presence of isolated ground structures, such ground induced noise resonances lead to pair-to-pair crosstalk.

A need remains for an electrical system that provides efficient shielding to meet particular performance demands.

### BRIEF DESCRIPTION OF THE INVENTION

In one embodiment, a receptacle assembly is provided that includes a contact module having a conductive holder and a frame assembly held by the conductive holder. The conductive holder has a first holder member and second holder member coupled to the first holder member. The conductive holder has a chamber between the first and second holder members divided into a plurality of channels by first tabs of the first holder member and second tabs of the second holder member. The first tabs have posts extending therefrom and the second tabs have holes receiving the posts of the first tabs. Each post has a plurality of termination points with the corresponding tab. The first and second holder members are electrically connected to one another at the termination points. The frame assembly includes at least one dielectric frame received in the first and second holder members. Each dielectric frame has a plurality of contacts and frame members supporting the contacts. The contacts are routed through corresponding channels and the first and second tabs passing between corresponding frame members.

Optionally, the holes may be open through the second holder member with the posts extending entirely through the second holder member. The posts may be cylindrical. The holes may have a plurality of flat walls each defining termination points with a corresponding post. The posts may engage each of the flat walls of the holes to mechanically and electrically secure the first holder member to the second holder member. The holes may have a polygonal cross section.

Optionally, each first tab may include a plurality of posts and each second tab may include a plurality of holes. The posts may extend between frame members of the second dielectric frame. Optionally, a first subset of the posts may have cylindrical posts and a second subset of the posts may have rectangular posts.

Optionally, the second holder member may include a second wall with the second tabs extending toward the first holder member from the second wall. The holes may extend through the second tabs and through the second wall. The holes may be surrounded on at least two opposite sides by the second tabs. The holes may be completely surrounded on all sides by the second wall. The holes may be bounded by flat walls. The holes may have tab portions through the second tabs and wall portions through the second wall. The tab portions may be bounded by less flat walls than the wall portions.

Optionally, the first tabs may have a first tab thickness. Each post may have a post thickness approximately equal to the corresponding first tab thickness. The first tabs may have a first section having a first tab thickness and a second section having a second tab thickness greater than the first tab thickness. Posts extending from the second section may be thicker than posts extending from the first section.

Optionally, the first tabs may each include first shoulders and the second tabs may each include second shoulders. The first and second tabs may be internested such that the first and second shoulders overlap each other. Optionally, the first tabs may include holes and the second tabs include posts. The posts of the second tabs may be received in corresponding holes of the first tabs.

In another embodiment, a receptacle assembly is provided including a contact module having a conductive holder and a frame assembly held by the conductive holder. The conductive holder includes a first holder member and second holder member coupled to the first holder member. The first holder member has a first wall with a plurality of first tabs extending from the first wall toward the second holder member. The first tabs have inner edges facing the second holder member. The first tabs have substantially cylindrical posts extending from the inner edges. Channels are defined between each of the first tabs. The second holder member has a second wall with a plurality of second tabs extending from the second wall toward the first holder member. The second tabs have inner edges facing the first holder member. Channels are defined between each of the second tabs. The second tabs have holes defined by a plurality of flat walls. The holes receive the posts of the first tabs such that each post engages each of the flat walls of the corresponding hole at a termination point. The first and second holder members are electrically connected to one another at the termination points. The frame assembly includes at least one dielectric frame received in the first and second holder members. Each dielectric frame includes a plurality of contacts and frame members supporting the contacts. The contacts are routed through corresponding channels. The first and second tabs passing between corresponding frame members.

### BRIEF DESCRIPTION OF THE DRAWINGS

FIG. 1 is a perspective view of an exemplary embodiment of an electrical connector system illustrating a receptacle assembly and a header assembly.

FIG. 2 is an exploded view of one of the contact modules and part of a shield structure shown in FIG. 1.

FIG. 3 illustrates one of the contact modules in an assembled state.

FIG. 4 is a side view of a holder member of the contact module formed in accordance with an exemplary embodiment.

FIG. 5 is a perspective view of the holder member.

FIG. 6 is a side view of another holder member formed in accordance with an exemplary embodiment.

FIG. 7 illustrates a portion of the holder member shown in FIG. 4.

FIG. 8 is a perspective view of a portion of the holder member shown in FIG. 6.

FIG. 9 is a front perspective view of a portion of the holder members being mated together.

### DETAILED DESCRIPTION OF THE INVENTION

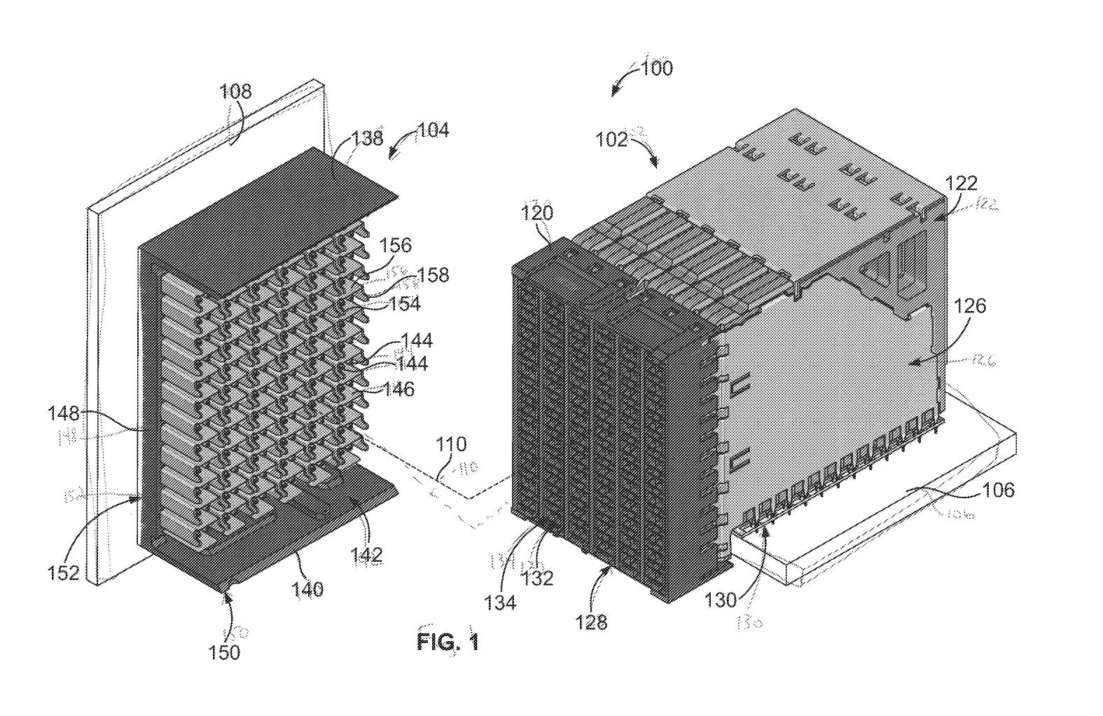

FIG. 1 is a perspective view of an exemplary embodiment of an electrical connector system 100 illustrating a receptacle assembly 102 and a header assembly 104 that may be directly mated together. The receptacle assembly 102 and/or the header assembly 104 may be referred to hereinafter individually as a “connector assembly” or collectively as “connector assemblies”. The receptacle and header assemblies 102, 104 are each electrically connected to respective circuit boards 106, 108.

A mating axis 110 extends through the receptacle and header assemblies 102, 104. The receptacle and header assemblies 102, 104 are mated together in a direction parallel to and along the mating axis 110. The receptacle and header assemblies 102, 104 are utilized to electrically connect the circuit boards 106, 108 to one another at a separable mating interface. In an exemplary embodiment, the circuit boards 106, 108 are oriented perpendicular to one another when the receptacle and header assemblies 102, 104 are mated. Alternative orientations of the circuit boards 106, 108 are possible in alternative embodiments.

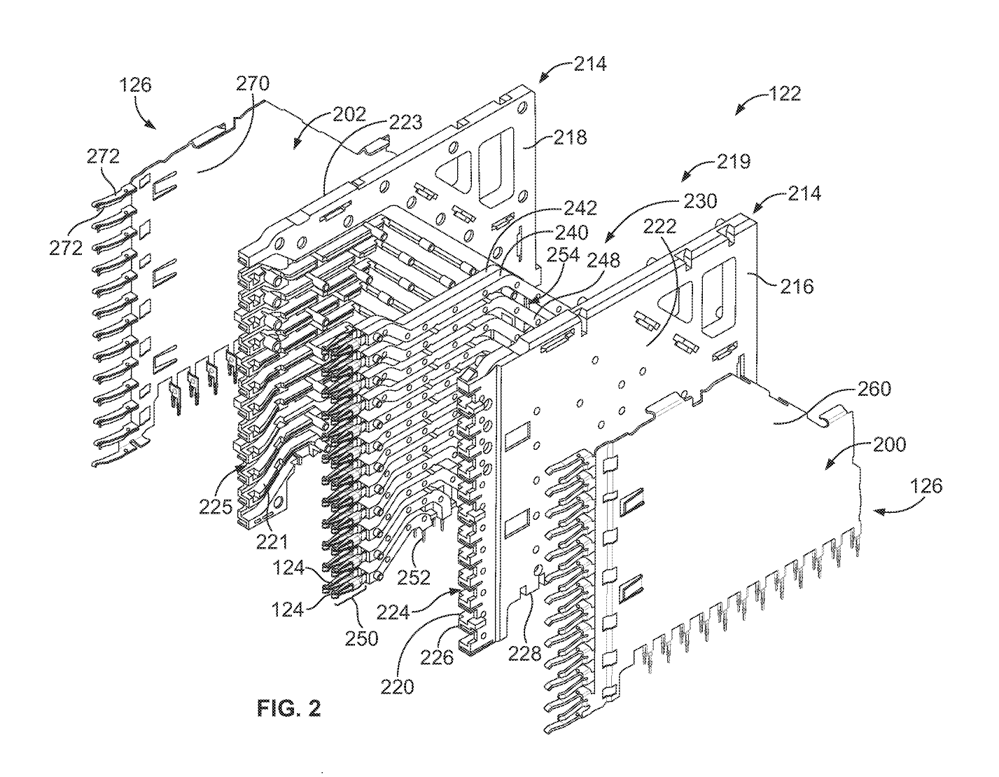

The receptacle assembly 102 includes a front housing 120 that holds a plurality of contact modules 122. Any number of contact modules 122 may be provided to increase the number of data channels between the circuit boards 106, 108. The contact modules 122 each include a plurality of receptacle signal contacts 124 (shown in FIG. 2) that are received in the front housing 120 for mating with the header assembly 104.

In an exemplary embodiment, each contact module 122 has a shield structure 126 for providing electrical shielding for the receptacle signal contacts 124. In an exemplary embodiment, the shield structure 126 is electrically connected to the header assembly 104 and/or the circuit board 106. For example, the shield structure 126 may be electrically connected to the header assembly 104 by extensions (e.g. beams or fingers) extending from the contact modules 122 that engage the header assembly 104. The shield structure 126 may be electrically connected to the circuit board 106 by features, such as ground pins. The shield structure 126 may provide shielding along substantially the entire length of the data channels between the circuit boards 106, 108.

The receptacle assembly 102 includes a mating end 128 and a mounting end 130. The receptacle signal contacts 124 are received in the front housing 120 and held therein at the mating end 128 for mating to the header assembly 104. The receptacle signal contacts 124 are arranged in a matrix of rows and columns. Any number of receptacle signal contacts 124 may be provided in the rows and columns. The receptacle signal contacts 124 also extend to the mounting end 130 for mounting to the circuit board 106. Optionally, the mounting end 130 may be substantially perpendicular to the mating end 128.

The front housing 120 includes a plurality of signal contact openings 132 and a plurality of ground contact openings 134 at the mating end 128. The receptacle signal contacts 124 are aligned with corresponding signal contact openings 132 for mating with corresponding header signal contacts 144 when the receptacle and header assemblies 102, 104 are mated. The ground contact openings 134 receive header shields 146 therein when the receptacle and header assemblies 102, 104 are mated. The shield structures 126 of the contact modules 122 are electrically connected with the header shields 146 to electrically common the receptacle and header assemblies 102, 104.

The front housing 120 is manufactured from a dielectric material, such as a plastic material, and provides isolation between the signal contacts 124, 144 and the header shields 146 and/or shield structure 126. The front housing 120 isolates each set of receptacle and header signal contacts 124, 144 from other sets of receptacle and header signal contacts 124, 144.

The header assembly 104 includes a header housing 138 having walls 140 defining a chamber 142. The header assembly 104 has a mating end 150 and a mounting end 152 that is mounted to the circuit board 108. Optionally, the mounting end 152 may be substantially parallel to the mating end 150. The receptacle assembly 102 is received in the chamber 142 through the mating end 150. The front housing 120 engages the walls 140 to hold the receptacle assembly 102 in the chamber 142. The header signal contacts 144 and the header shields 146 extend from a base wall 148 into the chamber 142. The header signal contacts 144 and the header shields 146 extend through the base wall 148 and are mounted to the circuit board 108.

In an exemplary embodiment, the header signal contacts 144 are arranged as differential pairs. The header shields 146 are positioned between the differential pairs to provide electrical shielding between adjacent differential pairs. In the illustrated embodiment, the header shields 146 are C-shaped and provide shielding on three sides of the corresponding pair of header signal contacts 144. The header shields 146 have a plurality of walls, such as three planar walls 154, 156, 158. The walls 154, 156, 158 may be integrally formed or alternatively, may be separate pieces. The wall 156 defines a center wall or top wall of the header shields 146. The walls 154, 158 define side walls that extend from the center wall 156. The header shield 146 associated with another pair of header signal contacts 144 provides shielding along the open, fourth side of the header shield 146 such that each of the pairs of signal contacts 144 is shielded from each adjacent pair in the same column and the same row. Other configurations or shapes for the header shields 146 are possible in alternative embodiments. More or less walls may be provided in alternative embodiments. The walls may be bent or angled rather than being planar. In other alternative embodiments, the header shields 146 may provide shielding for individual signal contacts 144 or sets of contacts having more than two signal contacts 144.

FIG. 2 is an exploded view of one of the contact modules 122 and part of the shield structure 126. The shield structure 126 includes a first ground shield 200 and a second ground shield 202. The first and second ground shields 200, 202 electrically connect the contact module 122 to the header shields 146 (shown in FIG. 1). The first and second ground shields 200, 202 provide multiple, redundant points of contact to the header shield 146. The first and second ground shields 200, 202 provide shielding on all sides of the receptacle signal contacts 124.

The contact module 122 includes a holder 214 having a first holder member 216 and a second holder member 218 that are coupled together to form the holder 214. When the holder members 216, 218 are coupled together, the first and second holder members 216, 218 define a chamber 219 that receives receptacle signal contacts 124. The holder members 216, 218 are fabricated from an electrically conductive material. For example, the holder members 216, 218 may be fabricated from a plastic material that has been metalized, plated or coated with a metallic layer. Alternatively, the holder members 216, 218 may be stamped and formed or may be die-cast from a metal material. By having the holder members 216, 218 fabricated from an electrically conductive material, the holder members 216, 218 may provide electrical shielding for the receptacle assembly 102. When the holder members 216, 218 are coupled together, the holder members 216, 218 define at least a portion of the shield structure 126 of the receptacle assembly 102.

The first and second holder members 216, 218 include first and second tabs 220, 221 extending inward toward one another from first and second walls 222, 223 of the holder members 216, 218, respectively. The tabs 220 define channels 224 therebetween. The tabs 221 define channels 225 therebetween. The tabs 220, 221 define at least a portion of the shield structure 126 of the receptacle assembly 102. When assembled, the holder members 216, 218 are coupled together and define a front 226 and a bottom 228 of the holder 214. The holder members 216, 218 are mechanically and electrically connected at multiple, redundant points of contact within the contact module 122 to create a reliable electrical connection therebetween at regular intervals. The multiple points of contact at regular intervals reduce low frequency noise resonance effects to control near end and/or far end cross talk and improve signal performance. The intervals can be selected to reduce the noise in certain ranges or below a certain threshold. For example, the intervals may be selected to reduce noise resonance effects at below 12.5 GHz. The intervals may be selected to reduce noise resonance effects at higher frequency ranges if desired.

The contact module 122 includes a frame assembly 230 held by the holder 214. The frame assembly 230 includes the receptacle signal contacts 124. The frame assembly 230 includes a pair of dielectric frames 240, 242 surrounding the receptacle signal contacts 124. In an exemplary embodiment, the receptacle signal contacts 124 are initially held together as lead frames (not shown), which are overmolded with dielectric material to form the first and second dielectric frames 240, 242. Manufacturing processes other than overmolding a leadframe may be utilized to form the contact modules 122, such as loading receptacle signal contacts 124 into a formed dielectric body.

The dielectric frame 240 includes a plurality of frame members 248. Each frame member 248 is formed around a different receptacle signal contact 124. Stated differently, each receptacle signal contact 124 extends along, and inside of, a corresponding frame member 248. The frame members 248 encase the receptacle signal contacts 124. The receptacle signal contacts 124 have mating portions 250 extending from the front and contact tails 252 extending from the bottom of the frame members 248. Other configurations are possible in alternative embodiments. Inner portions or encased portions of the receptacle signal contacts 124 transition between the mating portions 250 and the contact tails 252 within the dielectric frame 240.

The dielectric frame 240 includes a plurality of windows 254 extending through the dielectric frame 240 between the frame members 248. The windows 254 separate the frame members 248 from one another. In an exemplary embodiment, the windows 254 extend entirely through the dielectric frame 240. The windows 254 are internal of the dielectric frame 240 and located between adjacent receptacle signal contacts 124, which are held in the frame members 248. The windows 254 extend along lengths of the receptacle signal contacts 124 between the contact tails 252 and the mating portions 250. Optionally, the windows 254 may extend along a majority of the length of each receptacle signal contact 124 measured between the corresponding contact tail 252 and mating portion 250.

During assembly, the first dielectric frame 240 and corresponding receptacle signal contacts 124 are coupled to the first holder member 216. The frame members 248 are received in corresponding channels 224. The first tabs 220 are received in corresponding windows 254 such that the tabs 220 are positioned between adjacent receptacle signal contacts 124. The tabs 220 provide electrical shielding between the receptacle signal contacts 124 on either side of the tabs 220.

The second dielectric frame 242 is manufactured in a similar manner as the first dielectric frame 240 and includes similar components. The second dielectric frame 242 and corresponding receptacle signal contacts 124 are coupled to the second holder member 218 in a similar manner with the second tabs 221 extending through the windows 254 in the second dielectric frame 242. When the first and second dielectric frames 240, 242 are arranged in the holder members 216, 218, the receptacle signal contacts 124 are arranged as differential pairs. The tabs 220, 221 extend through the dielectric frames 240, 242 to provide shielding between the differential pairs of receptacle signal contacts 124. The first and second tabs 220, 221 have multiple points of contact therebetween to ensure electrical continuity of the shield structure 126 along the entire lengths of the receptacle signal contacts 124.

The holder members 216, 218, which are part of the shield structure 126, provide electrical shielding between and around respective receptacle signal contacts 124. The holder members 216, 218 provide shielding from electromagnetic interference (EMI) and/or radio frequency interference (RFI). The holder members 216, 218 may provide shielding from other types of interference as well. The holder members 216, 218 provide shielding around the outside of the frames 240, 242 and thus around the outside of all of the receptacle signal contacts 124, such as between pairs of receptacle signal contacts 124, as well as between the receptacle signal contacts 124 using the tabs 220, 221 to control electrical characteristics, such as impedance control, cross-talk control, and the like, of the receptacle signal contacts 124.

The first ground shield 200 includes a main body 260 configured to be coupled to the first wall 222 of the first holder member 216. The ground shield 200 includes grounding beams 262 extending forward from the main body 260. The grounding beams 262 are used to electrically connect the shield structure 126 to the corresponding header shield 146 (shown in FIG. 1). In an exemplary embodiment, the first ground shield 200 is manufactured from a metal material. The ground shield 200 is a stamped and formed part with the grounding beams 262 being stamped and formed out of plane with respect to the main body 260.

The second ground shield 202 includes a main body 270 configured to be coupled to the second wall 223 of the second holder member 218. The ground shield 202 includes grounding beams 272 extending forward from the main body 270. The grounding beams 272 are used to electrically connect the shield structure 126 to the corresponding header shield 146 (shown in FIG. 1). In an exemplary embodiment, the second ground shield 202 is manufactured from a metal material. The ground shield 202 is a stamped and formed part with the grounding beams 272 being stamped and formed out of plane with respect to the main body 270.

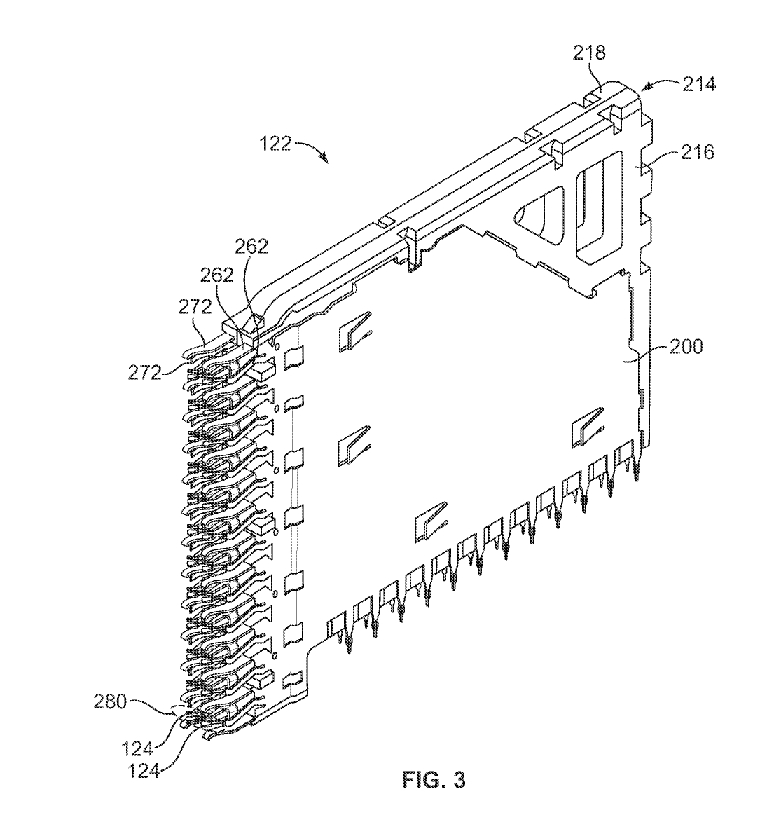

FIG. 3 illustrates one of the contact modules 122 in an assembled state. During assembly of the contact module 122, the dielectric frames 240, 242 (shown in FIG. 2) are received in the corresponding holder members 216, 218. The holder members 216, 218 are coupled together and generally surround the dielectric frames 240, 242. With the dielectric frames 240, 242 aligned adjacent one another in the holder 214, the receptacle signal contacts 124 are aligned with one another and define contact pairs 280. Each contact pair 280 is configured to transmit differential signals through the contact module 122.

The first and second ground shields 200, 202 (second ground shield 202 being shown in FIG. 2) are coupled to the holder 214 to provide shielding for the receptacle signal contacts 124. The grounding beams 262, 272 extend along the receptacle signal contacts 124. The first and second ground shields 200, 202 are configured to be electrically connected to the header shields 146 (shown in FIG. 1) when the receptacle assembly 102 is coupled to the header assembly 104 (shown in FIG. 1).

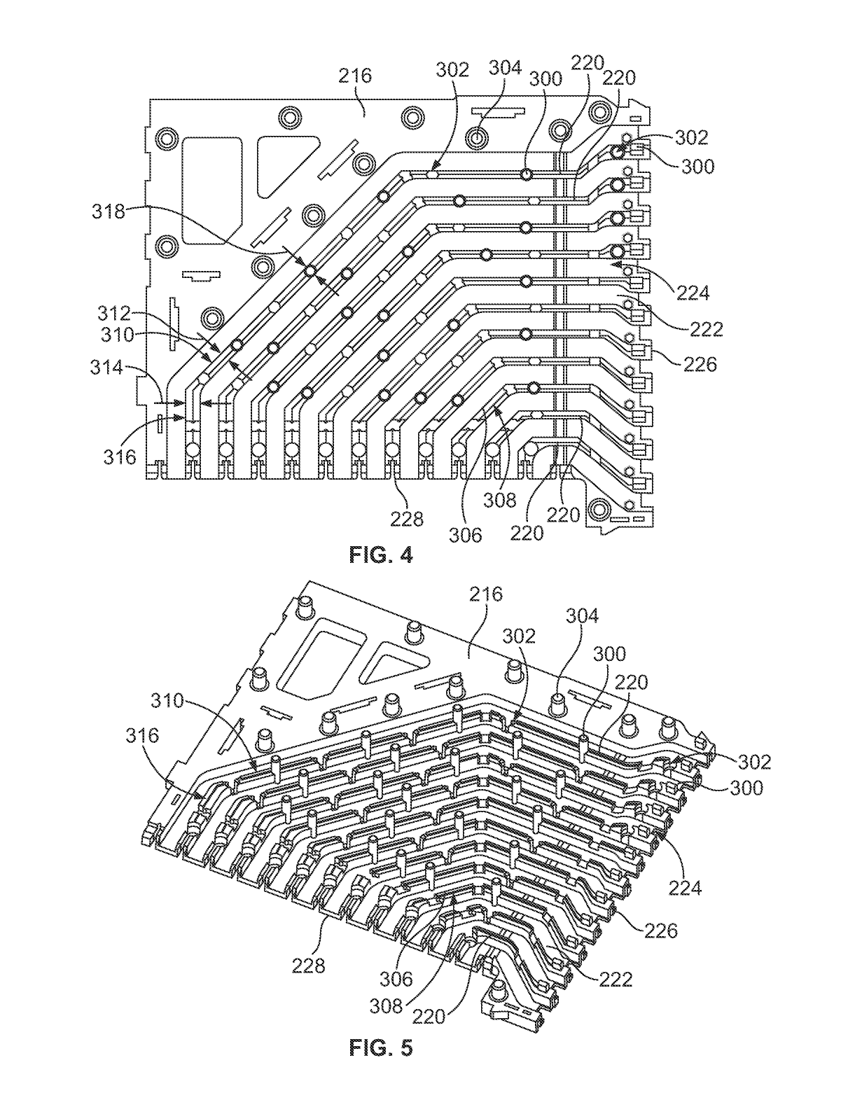

FIG. 4 is a side view of the first holder member 216 formed in accordance with an exemplary embodiment. FIG. 5 is a perspective view of the first holder member 216. FIGS. 4 and 5 illustrate the first tabs 220 extending from the first wall 222 to define the corresponding channels 224. The first tabs 220 and channels 224 transition between the front 226 and bottom 228 of the first holder member 216.

In an exemplary embodiment, the first holder member 216 includes a plurality of connection features that mechanically and electrically connect the first holder member 216 to the second holder member 218 (shown in FIG. 2). The multiple connection features create a reliable electrical connection between the first and second holder members 216, 218 to ensure that the shielding structure is electrically commoned at regular intervals to reduce the ground induced noise resonances that can be present in pair-to-pair cross talk. Having multiple electrical connections reduces the presence of isolated ground structures around the receptacle signal contacts, which may enhance the electrical performance of the receptacle assembly 102 (shown in FIG. 1).

In an exemplary embodiment, the connection features include first posts 300 arranged at intervals along the first tabs 220 and first holes 302 arranged at intervals along the first tabs 220. The intervals of the first post 300 and first holes 302 may not be equidistant along any particular first tab 220 or from one tab 220 to another tab 220, but rather may be arranged at intervals that are less than a preselected maximum interval. The maximum interval is selected to reduce or eliminate frequency noise resonance effects in a particular frequency range or below a predetermined frequency, such as below 12.5 GHz. Having a shorter maximum interval generally increases the frequency below which frequency noise resonance effects are reduced. For example, further decreasing of the spacing between the connection features may reduce frequency noise resonance effects below 12.5 GHz, below 20 GHz, or below other targeted frequencies. Any desired frequency range may be targeted and the corresponding spacing between the connection features may be set accordingly.

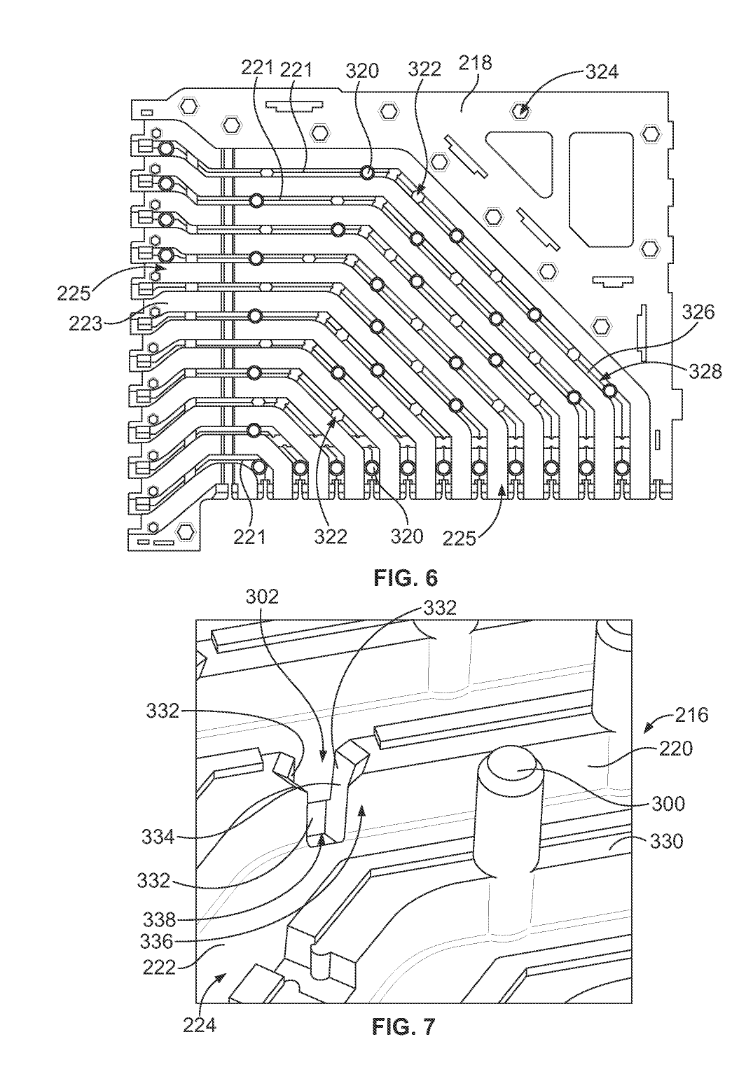

The first posts 300 are configured to be received in corresponding holes 322 (shown in FIG. 6) in the second holder member 218 while the first holes 302 are configured to receive corresponding posts 320 (shown in FIG. 6) extending from the second holder member 218, as described in further detailed below. The posts 300 and holes 302 may be arranged in any sequence, such as an alternating sequence of post-hole-post-hole along the first tab 220. Other sequences are possible in alternative embodiments.

Optionally, in an alternative embodiment, the first holder member 216 may include only posts 300 or only holes 302. Optionally, the first holder member 216 may include different sized and shaped posts 300 and holes 302 along the first tabs 220. Optionally, the first holder member 216 may include connection features in locations other than along the first tabs 220. For example, in the illustrated embodiment, the first holder member 216 includes outer posts 304 along surfaces of the first holder member 216 outside of the area of the first tabs 220.

In an exemplary embodiment, the connection features include first shoulders 306 along the first tabs 220. Each first shoulder 306 may be provided along the upper half of the corresponding first tab 220 and include a downward facing surface 308 that is configured to engage a corresponding shoulder of the second holder member 218. The first shoulders 306 may engage the second holder member 218 to create mechanical and/or electrical connection between the first holder member 216 and the second holder member 218.

Optionally, the first tabs 220 may have different thickness along different sections thereof, with the thickness dimension generally defined across the tab 220 between the adjacent channels 224 on either side of the corresponding tab 220. For example, the first tab 220 may have a first tab thickness 312 along a first section, generally identified as 310, while the first tab 220 may have a second tab thickness 314 along a second section, generally identified at 316. The second tab thickness 314 may be greater than the first tab thickness 312. The first posts 300 may have post thicknesses approximately equal to the corresponding tab thicknesses. Optionally, different subsets of the posts may have different thicknesses or diameters. For example, the first posts 300 along the first section 310 may have a first post thickness 318 approximately equal to the first tab thickness 312. Optionally, any posts along the second tab thickness 314 may have a post thickness approximately equal to the second tab thickness 314, thus providing two different sizes of posts.

Optionally, the first posts 300 may be cylindrical in shape. Alternatively, the first posts 300 may have other shapes, such as rectangular shapes. The first posts 300 may be elongated along the length of the tab 220, with the length of the tab 220 being defined in a direction generally parallel to the channels 224.

FIG. 6 is a side view of the second holder member 218 formed in accordance with an exemplary embodiment. FIG. 6 illustrates the second tabs 221 extending from the second wall 223 to define the corresponding channels 225.

In an exemplary embodiment, the second holder member 218 includes a plurality of connection features that mechanically and electrically connect the second holder member 218 to the first holder member 216 (shown in FIGS. 4 and 5). The multiple connection features create a reliable electrical connection between the first and second holder members 216, 218 to ensure that the shielding structure is electrically commoned at regular intervals to reduce the ground induced noise resonances that can be present in pair-to-pair cross talk. Having multiple electrical connections reduces the presence of isolated ground structures around the receptacle signal contacts, which may enhance the electrical performance of the receptacle assembly 102 (shown in FIG. 1).

In an exemplary embodiment, the connection features include second posts 320 arranged at intervals along the second tabs 221 and second holes 322 arranged at intervals along the second tabs 221. The intervals may be selected to reduce or eliminate frequency noise resonance effects in a particular frequency range or below a predetermined frequency, such as below 12.5 GHz. Any desired frequency range may be targeted and the corresponding spacing between the connection features may be set accordingly.

The second posts 320 are configured to be received in corresponding first holes 302 (shown in FIG. 4) in the first holder member 216 while the second holes 322 are configured to receive corresponding posts 300 (shown in FIGS. 4 and 5) extending from the first holder member 216. The posts 320 and holes 322 may be arranged in any sequence, such as an alternating sequence of post-hole-post-hole along the second tab 221. Other sequences are possible in alternative embodiments.

Optionally, in an alternative embodiment, the second holder member 218 may include only posts 320 or only holes 322. Optionally, the second holder member 218 may include different sized and shaped posts 320 and holes 322 along the second tabs 221. Optionally, the second holder member 218 may include connection features in locations other than along the second tabs 221. For example, in the illustrated embodiment, the second holder member 218 includes outer holes 324 along surfaces of the second holder member 218 outside of the area of the second tabs 221. The outer holes 324 are configured to receive the outer posts 304 (FIG. 5) of the first holder member 216.

In an exemplary embodiment, the connection features include second shoulders 326 along the second tabs 221. Each second shoulder 326 may be provided along the lower half of the corresponding second tab 221 and include an upward facing surface 328 that is configured to engage a corresponding first shoulder 306 (shown in FIGS. 4 and 5) of the first holder member 216. The second shoulders 326 may engage the first shoulders 306 to create mechanical and/or electrical connection between the first holder member 216 and the second holder member 218.

Optionally, the second tabs 221 may have different thickness along different sections thereof, with the thickness dimension generally defined across the tab 221 between the adjacent channels 225 on either side of the corresponding tab 221. Optionally, the second posts 320 may have post thicknesses approximately equal to the corresponding tab thicknesses.

Optionally, the second posts 320 may be cylindrical in shape. Alternatively, the second posts 320 may have other shapes, such as rectangular shapes. The second posts 320 may be elongated along the length of the corresponding tab 221, with the length of the tab 221 being defined in a direction generally parallel to the channels 225.

FIG. 7 illustrates a portion of the first holder member 216 showing one of the first posts 300 and one of the first holes 302. The second posts 320 and second holes 322 (both shown in FIG. 6) may be similar to the first posts 300 and first holes 302, respectively.

The first tabs 220 extend inward from the first wall 222 to an inner edge 330. The first post 300 extends from the inner edge 330. In the illustrated embodiment, the first post 300 is cylindrical in shape. The first post 300 has a circular cross section. However, other shapes are possible in alternative embodiments. The first post 300 is sized and shaped to fit in the corresponding second hole 322 when the first holder member 216 is coupled to the second holder member 218 (shown in FIG. 6). The first post 300 is an integral part of the first holder member 216 and may be co-molded or co-formed with other portions of the first holder member 216, such as the first tab 220 and the first wall 222.

The first hole 302 is sized and shaped to receive one of the second posts 320 (shown in FIG. 6). In an exemplary embodiment, the first hole 302 is bounded by a plurality of flat walls 332. Each flat wall 332 is configured to engage the corresponding second post 320 at a termination point 334, which may be approximately centered along the flat wall 332. Each second post 320 is configured to engage the first holder member 216 at a plurality of termination points 334 ensuring good electrical connection between the first holder member 216 and the second holder member 218. The first hole 302 has a tab portion 336 extending through the first tab 220 and a wall portion 338 extending through the first wall 222.

In the illustrated embodiment, the first holes 302 are generally hexagonal shaped, however other polygonal shaped holes may be used in alternative embodiments having a different number of flat walls 332 and/or open sides. The first hole 302 is open on at least two sides thereof (for example, two opposite sides of the hexagonal shaped hole 302) in the tab portion 336. The open sides may be open to the channels 224 on both sides of the tab 220. The tab portions 336 include four flat walls 332 defining multiple termination points 334 with the second post 320 when received therein. For example, the first holes 302, in the tab portions 336, are surrounded on at least two sides by the first tabs 220. Each of the tab portions 336 on the opposite sides of the first holes 302 have at least two flat walls 332 defining termination points 334. The wall portion 338 is bounded on all sides by flat walls 332, such as by six flat walls 332.

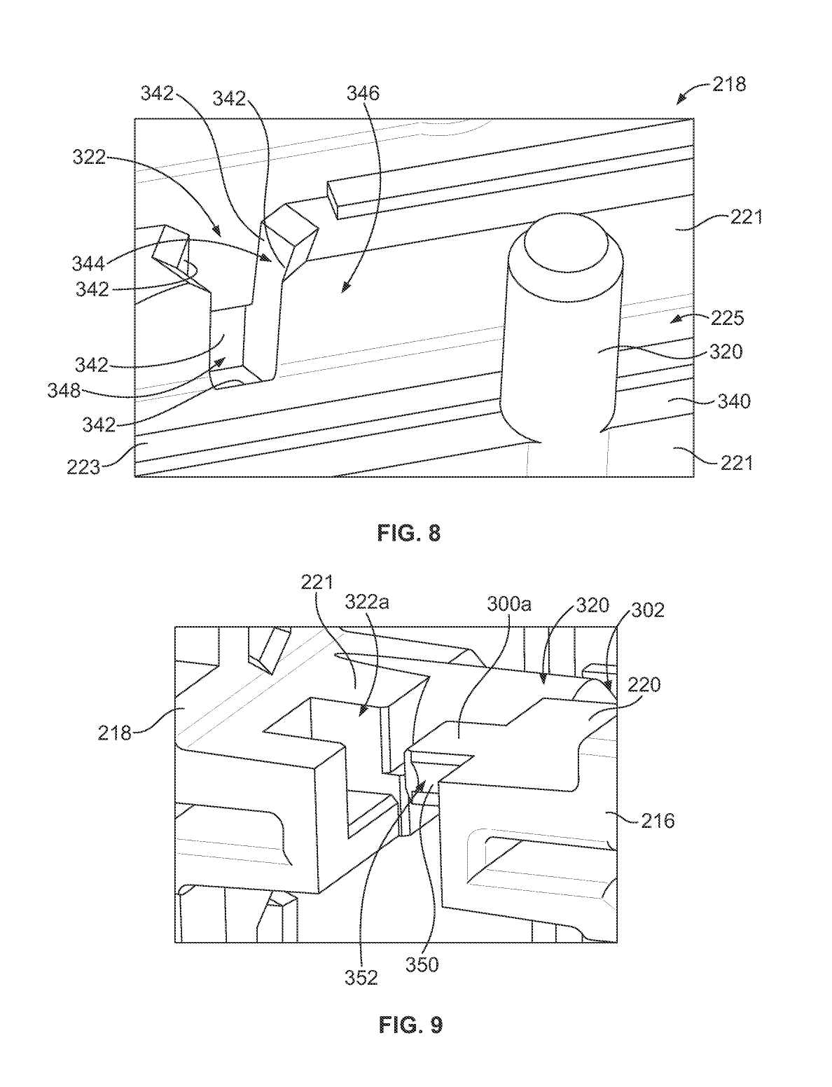

FIG. 8 is a perspective view of a portion of the second holder member 218 showing one of the second posts 320 and one of the holes 322. The second tabs 221 extend inward from the second wall 223 to an inner edge 340. The second post 320 extends from the inner edge 340. In the illustrated embodiment, the second post 320 is cylindrical in shape. The second post 320 has a circular cross section. However, other shapes are possible in alternative embodiments. The second post 320 is sized and shaped to fit in the corresponding first hole 302 (shown in FIG. 7) when the first holder member 216 (shown in FIG. 7) is coupled to the second holder member 218. The second post 320 is an integral part of the second holder member 218 and may be co-molded or co-formed with other portions of the second holder member 218, such as the second tab 221 and the second wall 223.

The second hole 322 is sized and shaped to receive one of the first posts 300 (shown in FIG. 7). In an exemplary embodiment, the second hole 322 is bounded by a plurality of flat walls 342. Each flat wall 342 is configured to engage the corresponding first post 300 at a termination point 344, which may be approximately centered along the flat wall 342. Each first post 320 is configured to engage the second holder member 218 at a plurality of the termination points 344 ensuring good electrical connection between the first holder member 216 and the second holder member 218. The second hole 322 has a tab portion 346 extending through the second tab 221 and a wall portion 348 extending through the second wall 223.

In the illustrated embodiment, the second hole 322 is generally hexagonal shaped, however other polygonal shaped holes may be used in alternative embodiments having a different number of flat walls 342 and/or open sides. The second hole 322 is open on at least two sides thereof (for example, two opposite sides of the hexagonal shaped hole 322) in the tab portion 346. The open sides may be open to the channels 225 on both sides of the tab 221. The tab portions 346 include four flat walls 342 defining multiple termination points 344 with the first post 300 when received therein. For example, the second hole 322, in the tab portions 346, is surrounded on at least two sides by the second tab 221. Each of the tab portions 346 on the opposite sides of the second hole 322 have at least two flat walls 342 defining termination points 344. The wall portion 348 is bounded on all sides by flat walls 342, such as by six flat walls 342.

FIG. 9 is a front perspective view of a portion of the holder 214 (shown in FIGS. 2 and 3) showing the first holder member 216 and the second holder member 218 poised for mating together. While FIGS. 7 and 8 illustrated cylindrical posts 300, 320 and hexagonal shaped holes 302, 322, the first and second holder member 216, 218 may include other types of post and holes. In the illustrated embodiment, the first holder member 216 includes a rectangular shaped first post 300a and the second holder member 218 includes a rectangular shaped second hole 322a that receives the first post 300a. The rectangular posts and holes 300a, 322a generally define a tongue and a groove interface. The posts and holes 300, 322 may be referred to hereinafter as a tongue 300a and a groove 322a, respectively. In an exemplary embodiment, the tongue 300a and groove 322a are provided at the front 226 (FIG. 2) of the holder 214; however the tongue 300a and groove 322a may be positioned at any location along the first and second tabs 220, 221. The tongue 300a includes ribs 350 along both sides thereof. The ribs 350 may be crush ribs. The ribs 350 define termination points 352 that create an electrical and mechanical connection between the first holder member 216 and the second holder member 218. The cylindrical posts 300, 320 may include ribs to define the termination points.

FIG. 9 also illustrates one of the second posts 320 being loaded into one of the first holes 302. When the second post 320 is received in the first hole 302, the second post 320 is positioned between the channels 224 (FIGS. 4 and 5) of the first holder member 216. The second post 320 is positioned directly between receptacle signal contacts 124 (shown in FIG. 2) that are routed in the channels 224 both above and below the second post 320. The second post 320 provides electrical shielding within the contact plane of the first dielectric frame 240 (shown in FIG. 2).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A receptacle assembly comprising:
a contact module comprising a conductive holder and a frame assembly held by the conductive holder;
the conductive holder comprising a first holder member and second holder member coupled to the first holder member, the conductive holder having a chamber between the first and second holder members, the chamber being divided into a plurality of channels by first tabs of the first holder member and second tabs of the second holder member, the first tabs having posts extending therefrom, the second tabs having holes receiving the posts of the first tabs, each post having a plurality of termination points with the corresponding tab, the first and second holder members being electrically connected to one another at the termination points;
the frame assembly comprising at least one dielectric frame received in the first and second holder members, each dielectric frame comprising a plurality of contacts and frame members supporting the contacts, the contacts being routed through corresponding channels, the first and second tabs disposed between corresponding frame members.

2. The receptacle assembly of claim 1, wherein the holes are open through the second holder member, the posts extending entirely through the second holder member.

3. The receptacle assembly of claim 1, wherein the posts are substantially cylindrical, the holes having a plurality of flat walls each defining termination points with a corresponding post.

4. The receptacle assembly of claim 1, wherein the holes have a polygonal cross section, the posts having a generally circular cross section and engaging each of the flat walls of the holes to mechanically and electrically secure the first holder member to the second holder member.

5. The receptacle assembly of claim 1, wherein each first tab includes a plurality of posts and each second tab includes a plurality of holes.

6. The receptacle assembly of claim 1, wherein the posts and holes are spaced apart at intervals sufficient to substantially eliminate frequency noise resonance effects below 12.5 GHz.

7. The receptacle assembly of claim 1, wherein the posts extend between frame members of the corresponding dielectric frame.

8. The receptacle assembly of claim 1, wherein the second holder member includes a second wall, the second tabs extending toward the first holder member from the second wall, the holes extending through the second tabs and through the second wall.

9. The receptacle assembly of claim 8, wherein the holes are surrounded on at least two opposite sides by the second tabs, the holes being completely surrounded on all sides by the second wall.

10. The receptacle assembly of claim 8, wherein the holes are bounded by flat walls, the holes having tab portions through the second tabs and wall portions through the second wall, the tab portions bounded by fewer of the flat walls than of the wall portions.

11. The receptacle assembly of claim 1, wherein the first tabs have a first tab thickness, each post having a post thickness approximately equal to the corresponding first tab thickness.

12. The receptacle assembly of claim 1, wherein the first tabs have a first section having a first tab thickness and a second section having a second tab thickness greater than the first tab thickness, the posts extending from the second section being thicker than the posts extending from the first section.

13. The receptacle assembly of claim 1, wherein a first subset of the posts have cylindrical posts and a second subset of the posts have rectangular posts.

14. The receptacle assembly of claim 1, wherein the first tabs each include first shoulders and the second tabs each include second shoulders, the first and second tabs being internested such that the first and second shoulders overlap each other.

15. The receptacle assembly of claim 1, wherein the first tabs include holes and the second tabs include posts, the posts of the second tabs being received in corresponding holes of the first tabs.

16. A receptacle assembly comprising:
a contact module comprising a conductive holder and a frame assembly held by the conductive holder;
the conductive holder comprising a first holder member and second holder member coupled to the first holder member, the first holder member having a first wall with a plurality of first tabs extending from the first wall toward the second holder member, the first tabs having inner edges facing the second holder member, the first tabs having substantially cylindrical posts extending from the inner edges, channels being defined between each of the first tabs, the second holder member having a second wall with a plurality of second tabs extending from the second wall toward the first holder member, the second tabs having inner edges facing the first holder member, channels being defined between each of the second tabs, the second tabs having holes defined by a plurality of flat walls, the holes receiving the posts of the first tabs such that each post engages each of the flat walls of the corresponding hole at a termination point, the first and second holder members being electrically connected to one another at the termination points;
the frame assembly comprising at least one dielectric frame received in the first and second holder members, each dielectric frame comprising a plurality of contacts and frame members supporting the contacts, the contacts being routed through corresponding channels, the first and second tabs disposed between corresponding frame members.

17. The receptacle assembly of claim 16, wherein the holes are open through the second holder member, the posts extending entirely through the second holder member.

18. The receptacle assembly of claim 16, wherein the holes have a polygonal cross section, the posts engaging the corresponding flat walls of the holes to mechanically and electrically secure the first holder member to the second holder member.

19. The receptacle assembly of claim 16, wherein each first tab includes a plurality of the posts and each second tab includes a plurality of the holes.

20. The receptacle assembly of claim 16, wherein the first tabs include holes and the second tabs include posts, the posts of the second tabs being received in corresponding holes of the first tabs.
